(19) United States
(12) Patent Application Publication
(10) Pub. No.: US 2006/0126546 A1
(43) Pub. Date: Jun. 15, 2006

(54) Enhanced hybrid duplexing technology-based wireless communication system

(75) Inventors: Yeon-Woo Lee, Seongnam-si (KR); Sang-Boh Yun, Seongnam-si (KR); Seung-Young Park, Yongin-si (KR); Won-Hyoung Park, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/285,453

(22) Filed: Nov. 22, 2005

(30) Foreign Application Priority Data
Dec. 10, 2004 (KR) 2004-104127

(51) Int. Cl. H04B 7/00

(52) U.S. Cl. 370/310

(57) ABSTRACT

A wireless communication system in an overlay network where systems using different frequency bands coexist. The wireless communication system includes at least one first duplexing system utilizing a first duplexing technique through a first frequency band, and at least one second duplexing system utilizing a second frequency band and a part of the first frequency band. The second duplexing system overlaps with the first duplexing system in coverage.

### PRIORITY

This application claims priority under 35 U.S.C. § 119 to an application entitled “Enhanced Hybrid Duplexing Technology-Based Wireless Communication System” filed in the Korean Intellectual Property Office on Dec. 10, 2004 and assigned Serial No. 2004-104127, the contents of which are incorporated herein by reference.

### BACKGROUND OF THE INVENTION

1. Field of the Invention

The present invention relates generally to a wireless communication system, and in particular, to a communication system and method capable of improving resource allocation flexibility and maximizing system performance through enhanced hybrid duplexing technology (EHDT) that selectively uses various duplex modes.

2. Description of the Related Art

Next generation wireless communication systems, including the 3^{rd} generation (3G) mobile communication system, attempt to support a voice service and multimedia services having various traffic characteristics, e.g., broadcasting and real-time video conference services. In order to efficiently provide the multi-characteristic services, there is a need for a duplexing technique that takes into account the asymmetry and continuity of uplink and downlink transmission according to the service characteristics.

Generally, the duplexing technique is classified into Time Division Duplexing (TDD) and Frequency Division Duplexing (FDD). TDD divides the same frequency band into time periods and alternately switches transmission bands and reception bands, thereby implementing bidirectional communication. FDD divides a given frequency band into transmission bands and reception bands, thereby realizing bidirectional communication.

In a TDD-based communication system, a base station can allocate all or some of available time slots to a mobile station, and enables asymmetric communication through variable allocation of the time slots. However, in TDD, an increase in cell radius increases a guard interval between transmission and reception time slots due to a round trip delay, thereby reducing transmission efficiency. Therefore, in a communication environment of a cell with a large radius such as a macro cell, it is not preferable to use TDD. In addition, in a multicell environment, because cells are not equal to each other in the asymmetry ratio, TDD causes serious frequency interference between mobile stations located in a boundary between neighbor cells.

In an FDD-based communication system, because transmission frequency bands are separated from reception frequency bands, there is no time delay for transmission or reception. As a result, there is no need for a round trip delay caused by a time delay, so that FDD is appropriate for a communication environment of a cell with a large radius such as a macro cell. However, FDD is not appropriate as duplexing technology for asymmetric transmission, because transmission frequency bands and reception frequency bands are fixed.

Accordingly, there is a need to develop hybrid duplexing techniques that use both of the two duplexing schemes in consideration of the various communication environments and traffic characteristics of the next generation wireless communication system.

However, the conventional hybrid duplexing technique has been proposed for an infrastructure hierarchical network, and does not take into account an overlay system network in which the conventional network overlaps another network.

More specifically, even though most of a 3G standardization is complete, no detailed method for applying a hybrid duplexing technique has been proposed that takes into account the overlay network in which the next generation systems, which are roughly classified into the 3G system and an ad hoc network, overlap each other, and there is a limitation in applying the conventional hybrid duplexing technique to the overlay network.

### SUMMARY OF THE INVENTION

To address the above and other problems, the present invention provides an Enhanced Hybrid Duplexing Technology (EHDT) wireless communication system and method for efficient resource allocation in an overlay network in which different type systems coexist.

To achieve the above and other objects, a wireless communication system is provided in an overlay network where systems using different frequency bands coexist. The system includes at least one first duplexing system operating based on a first duplexing technique through a first frequency band; and at least one second duplexing system operating using a second frequency band and a part of the first frequency band, the second duplexing system overlapping with the first duplexing system in coverage.

Additionally, there is provided a wireless communication method in an overlay network where different types of cellular systems for providing a communication service to mobile stations in their coverage area using different frequency bands coexist. The method includes the steps of: receiving, by a current system associated with a mobile station, a request for resource of a different type system from the mobile station; determining if there is available resource of the different type system; determining if the current system is located in a boundary of the different type system, if there is available resource of the different type system; and allocating resources of the different type system to the mobile station, if the current system is not located in a boundary of the different type system.

### BRIEF DESCRIPTION OF THE DRAWINGS

The above and other objects, features, and advantages of the present invention will become more apparent from the following detailed description when taken in conjunction with the accompanying drawings in which:

FIG. 1 is a schematic diagram illustrating an overlay network to which an EHDT duplexing method according to the present invention is applicable;

FIG. 2A is a conceptual diagram illustrating an EHDT duplexing method according to an embodiment of the present invention;

FIG. 2B is a system configuration diagram illustrating the EHDT system according to an embodiment of the present invention;

FIG. 2C is a conceptual diagram illustrating resource allocation in the EHDT system according to an embodiment of the present invention;

FIG. 3 is a schematic diagram illustrating a resource sharing technique for an EHDT system according to an embodiment of the present invention;

FIG. 4 is a flowchart illustrating an EHDT duplexing method according to an embodiment of the present invention;

FIG. 5 is a conceptual diagram illustrating an EHDT duplexing method according to an embodiment of the present invention;

FIG. 6 is a resource graph illustrating an FDD mode of an HDT system in an EHDT duplexing method according to an embodiment of the present invention;

FIG. 7 is a flowchart illustrating an EHDT duplexing method according to an embodiment of the present invention; and

FIG. 8 is a conceptual diagram illustrating an EHDT duplexing method according to an embodiment of the present invention.

### DETAILED DESCRIPTION OF THE PREFERRED EMBODIMENT

Several preferred embodiments of the present invention will now be described in detail with reference to the annexed drawings. In the following description, a detailed description of known functions and configurations incorporated herein has been omitted for conciseness.

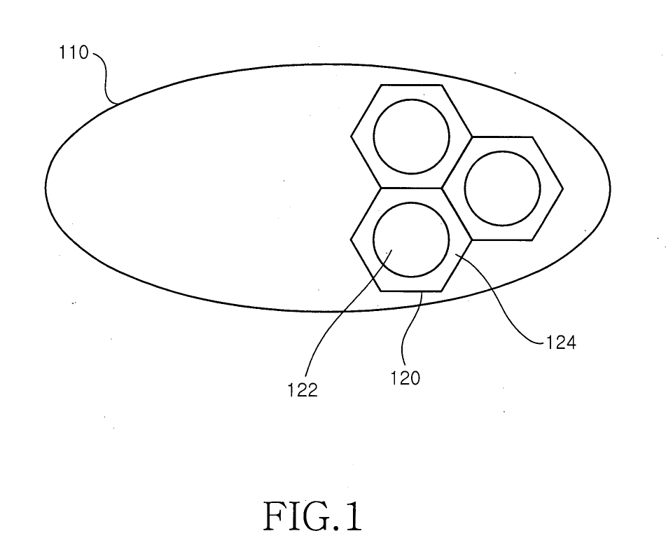

FIG. 1 is a schematic diagram illustrating an overlay network to which an EHDT duplexing method according to the present invention is applicable. As illustrated in FIG. 1, the present invention is applied to a cellular environment in which a cluster of micro cells (or pico cells) 120 are formed within a macro cell 110 with wider coverage on an overlapping basis. Each of the micro cells 120 is divided into an inner region 122 and an outer region 124.

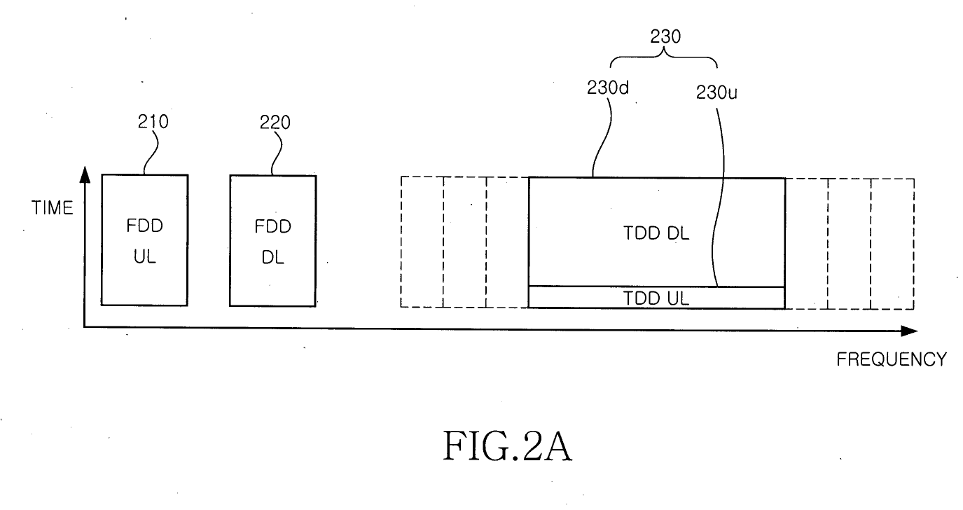

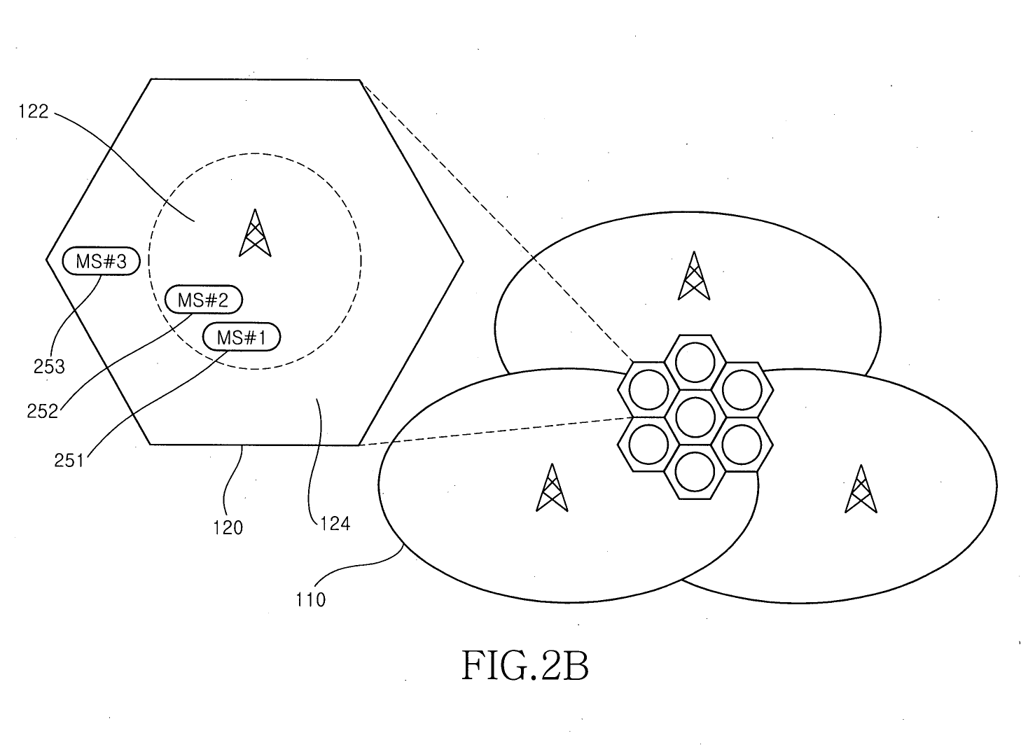

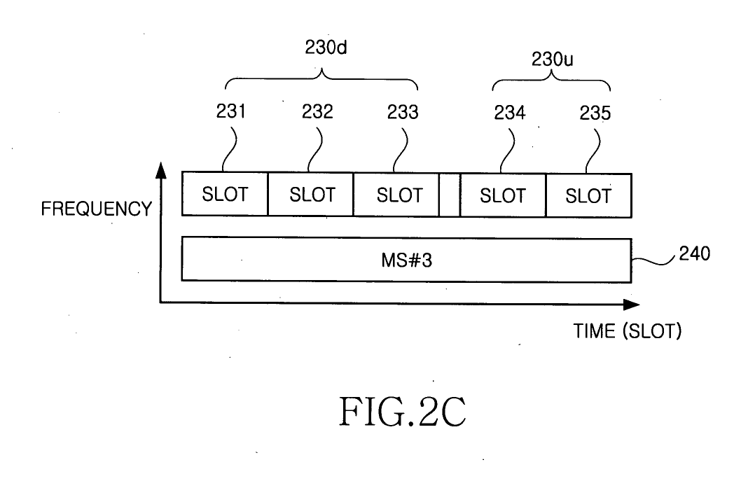

FIG. 2A is a conceptual diagram illustrating an EHDT duplexing method according to an embodiment of the present invention. More specifically, FIG. 2A illustrates a hybrid duplexing method using an FDD uplink band 210, an FDD downlink band 220, and a newly proposed additional band 230.

Referring to FIG. 2A, the macro cell 110 is implemented with an FDD system that uses the existing FDD uplink resource 210 and downlink resource 220, and the micro cell 120 is implemented with a hybrid duplexing system that uses the additional TDD resource 230 and the existing FDD uplink resource 210. That is, the micro cell 120 allocates TDD downlink resource 230d and TDD uplink resource 230u in the additional band 230 to a mobile station located in the inner region 122, and allocates the TDD downlink resource 230d and the FDD uplink resource 210 to a mobile station located in the outer region 124.

In the EHDT system, the FDD uplink resource 210 can be designed such that it separately includes a sharing band shared by the FDD system and a hybrid duplexing system, or borrows FDD uplink resource unused by the FDD system at the request of the HDT system.

FIG. 2B is a system configuration diagram illustrating the EHDT system according to an embodiment of the present invention, and FIG. 2C is a conceptual diagram illustrating resource allocation in the EHDT system according to an embodiment of the present invention. Referring to FIGS. 2B and 2C, in an overlay system in which FDD macro cells and HDT micro cells overlap each other, if a mobile station (MS) #1 251 and a mobile station #2 252 are located in an inner region 122 of a micro cell 120, the mobile station #2 252 is located nearer to an outer region 124 compared with the mobile station #1 251, and a mobile station #3 253 is located in the outer region 124, the micro cell 120 allocates a slot #3 233 of TDD downlink resource 230d and a slot #4 234 of TDD uplink resource 230u to the mobile station #1 251, allocates a slot #2 232 of the TDD downlink resource 230d and a slot #5 235 of the TDD uplink resource 230u to the mobile station #2 252, and allocates a slot #1 231 of the TDD downlink resource 230d and FDD uplink resource 240 to the mobile station #3 253. The FDD uplink resource 240, i.e., a part of the FDD uplink resource 210 for a macro cell 110, is shared by the micro cell 120 and the macro cell 110 or borrowed by the micro cell 120 when necessary.

In order for the HDT system for the micro cell 120 to share the resources with the FDD system for the macro cell 110 or borrow unused resources of the FDD system, the two systems are connected to a radio network controller (RNC) or a mobile switching center (MSC). Accordingly, the HDT system shares uplink resource information with FDD systems connected to the RNC.

When an HDT system (micro cell) is located in an FDD system (macro cell), it is possible for the HDT system to share/borrow uplink resources of the same FDD cell. As long as there is no interference, the HDT system can borrow uplink resources for neighbor FDD systems.

When an HDT system is located in a boundary between two FDD systems, the HDT system determines one FDD system that it desires to use, according to conditions of available uplink resources of neighbor FDD systems, such as positions of mobile stations located in the outer region 124 and signal-to-interference plus noise ratio (SINR) levels, or reception signal levels, for the neighbor FDD systems.

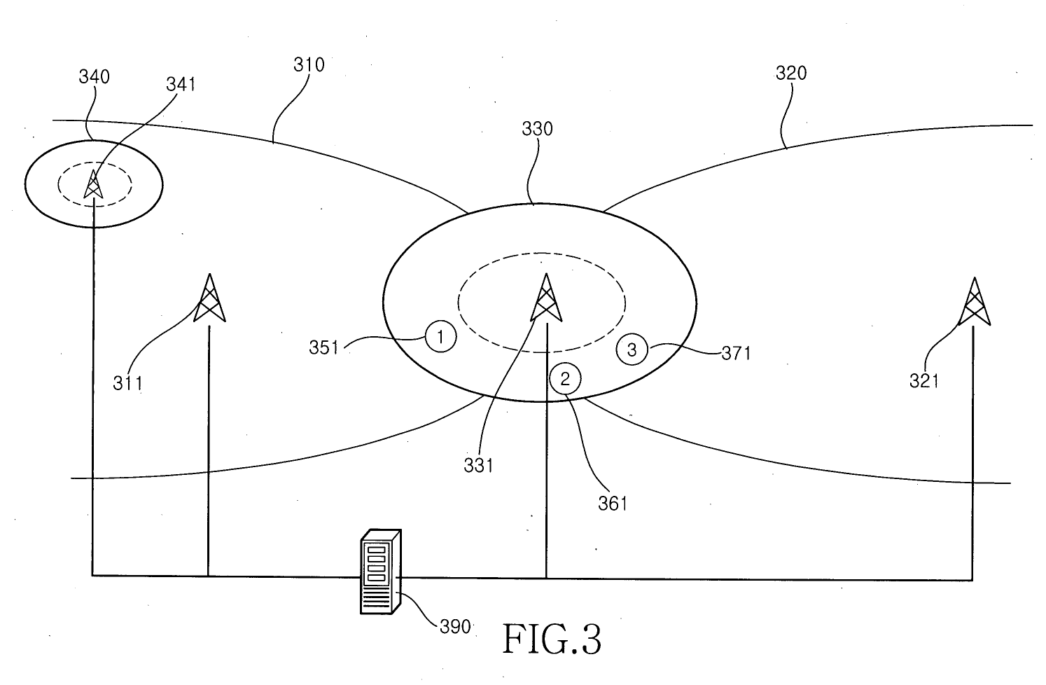

FIG. 3 is a schematic diagram illustrating a resource sharing technique for an EHDT system according to an embodiment of the present invention. In FIG. 3, two FDD systems 310 and 320 and two HDT systems 330 and 340 are deployed, and base stations 311, 321, 331, and 341 of the systems are connected to an RNC 390 with a wire network. More specifically, the HDT system 330 is located in a boundary of the FDD system #1 310 and the FDD system #2 320. A mobile station #1 351, a mobile station #2 361, and a mobile station #3 371 are located in an outer region of the HDT system 330, and connected to the HDT base station 331.

In this situation, the HDT system #1 330 shares uplink resources of the FDD system #1 310. Therefore, the mobile stations, 351, 361, and 371 transmit signals through the uplink resources of the FDD system #1 310 with the power requested by the HDT base station 331. In this case, the uplink signals transmitted by the mobile stations 351, 361, and 371 may interfere with the FDD system #2 320.

In FIG. 3, if the mobile station #1 351, the mobile station #2 361, and the mobile station #3 371 have the same SINR level, interference of the mobile station #3 371 to the FDD system #2 320 is greater than interference of the mobile station #1 351 and the mobile station #2 361 to the FDD system #2 320. Therefore, the HDT system #1 330 determines which FDD system's uplink resources it will use according to SINR levels for neighbor FDD systems of the mobile stations. The mobile stations transmit uplink signals to the HDT base station with power lower than the uplink power used for direct transmission to the FDD base station.

The EHDT system according to the present invention can reuse uplink resources of another neighbor FDD system as uplink resources for a mobile station located in an outer region of an HDT system. In this case, there is no need for control by the RNC, contributing to a reduction in the amount of control channel information.

If the FDD system is a Code Division Multiple Access (CDMA) system (interference limited system), an HDT cell can reuse uplink codes used in another FDD system or independently allocate uplink codes. If the FDD system is a Frequency Division Multiple Access (FDMA) or Orthogonal Frequency Division Multiple Access (OFDMA) system (resource limited system), the HDT cell can orthogonally allocate frequency resources (or frequency patterns) allocated to an uplink for the same FDD cell, or can apply frequency reuse division or frequency reuse allocation with a cell.

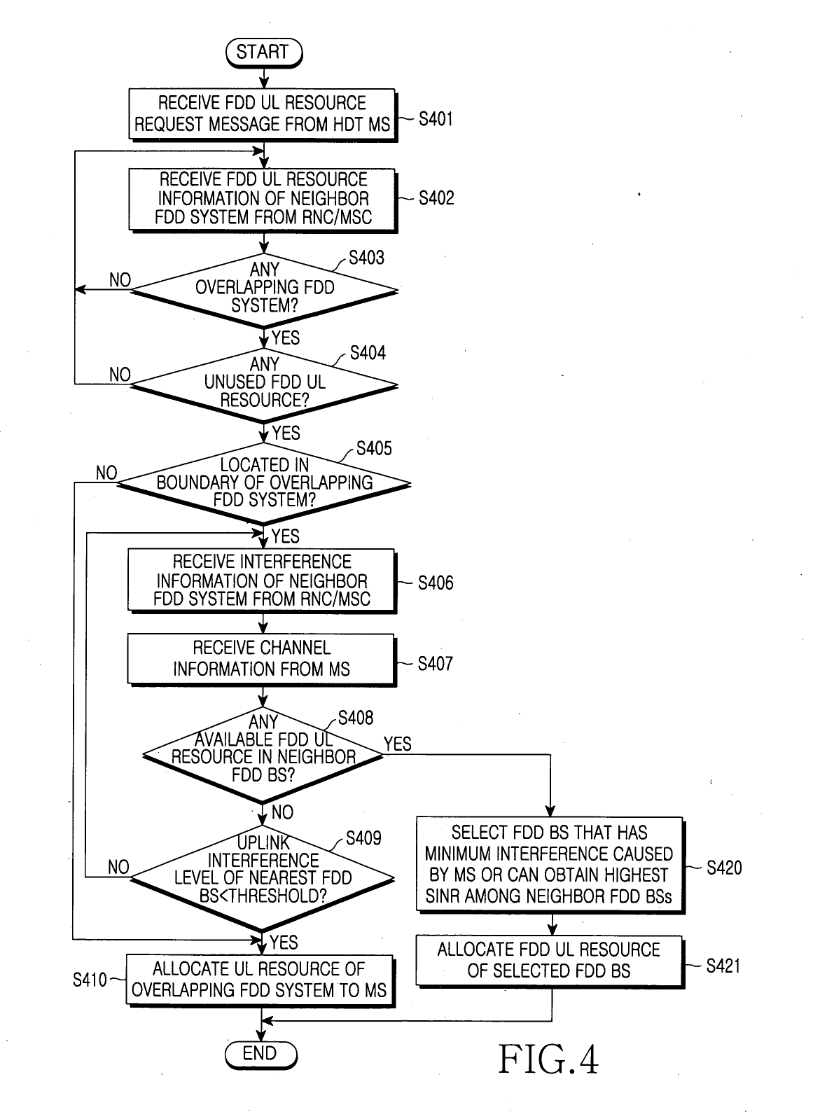

FIG. 4 is a flowchart illustrating an EHDT duplexing method according to an embodiment of the present invention. Referring to FIG. 4, if an HDT system receives an FDD uplink resource request message from an HDT mobile station in step S401, after making call setup at the request of the HDT mobile station located in its coverage, the HDT system transmits a request for FDD uplink resource information of neighbor FDD base stations and receives corresponding information provided from an RNC (or MSC) in step S402. Alternatively, the HDT system can periodically receive the FDD uplink resource information of the neighbor FDD systems from the RNC, without the request of the HDT base station.

In step S403, the HDT system determines if there is an overlapping FDD base station whose coverage overlaps with its own coverage, based on the information provided from the RNC. If there is an overlapping FDD system, in step S404, the HDT system determines if there are available unused FDD uplink resources in the overlapping FDD system. If there are unused FDD uplink resources, the HDT system determines if it is located in a boundary of the overlapping FDD system in step S405. If the HDT system is not located in a boundary of the overlapping FDD system, the HDT system allocates uplink resource of the overlapping FDD system to the HDT mobile station in step S410.

However, if the HDT system is located in the boundary of the overlapping FDD system, the HDT system receives, from the RNC, information on the amount of interference to the HDT system, caused by neighbor FDD systems, in step S406, and receives channel information from the HDT mobile station in step S407. Preferably, the channel information can include path gain, SINR level, and reception power level of the corresponding channel.

Subsequently, the HDT system determines if there are available FDD uplink resources in the neighbor FDD systems in step S408. If there is no available resource in any neighbor FDD system, the HDT system determines if a co-channel uplink interference level of the nearest FDD system is lower than a threshold in step S409.

If the interference level of the nearest FDD system is lower than the threshold, the HDT system allocates uplink resource of the overlapping FDD system to the HDT mobile station in step S410.

If it is determined in step S408 that there are available FDD uplink resources in the neighbor FDD systems, the HDT system selects, among the neighbor FDD systems, an FDD system that has the minimum co-channel interference caused by the HDT mobile station or can obtain the highest SINR level in step S420, and allocates FDD uplink resource of the selected FDD system to the HDT mobile station in step S421.

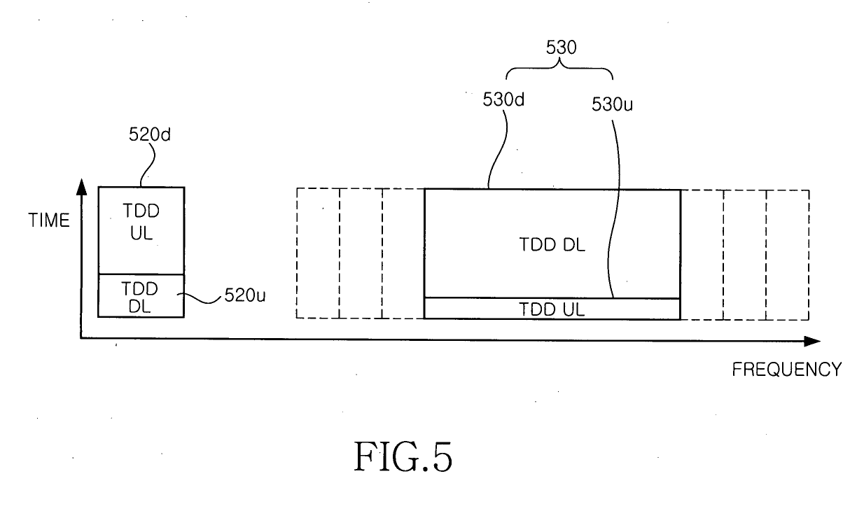

FIG. 5 is a conceptual diagram illustrating an EHDT duplexing method according to and embodiment of the present invention. More specifically, FIG. 5 illustrates a hybrid duplexing method using the existing narrowband TDD uplink resource 520u and downlink resource 520d, and TDD resources of the newly proposed additional band 530.

Referring to FIG. 5, a macro cell 110 is implemented with a narrowband TDD system that uses the existing narrowband TDD uplink resource 520u and downlink resource 520d, and a micro cell 120 is implemented with a hybrid duplexing (HDT) system that uses the broadband TDD resources of the additional band 530 and the existing narrowband TDD uplink resource 520u. The micro cell 120 allocates uplink resource 530u and downlink resource 530d of the additional TDD band 530 to a mobile station located in an inner region 122 thereof, and allocates the TDD downlink resource 530d of the additional broadband 530 and the narrowband TDD uplink resource 520u to a mobile station located in an outer region 124 thereof.

The narrowband TDD uplink resource 520u is shared by a TDD system 110 implemented with a macro cell and an HDT system 120 implemented with a micro cell, or a part thereof is previously allocated for the HDT system 120. The HDT system checks availability of the narrowband TDD uplink resource 520u at the request of a mobile station, and dynamically shares (or borrows) the narrowband TDD uplink resource 520u according to the check result.

In a technique of previously allocating the narrowband TDD uplink resource 520u for the HDT system 120, the HDT system 120 analyzes the amount of resources required by mobile stations at every frame or every session, and allocates a predetermined amount of the TDD uplink resource 520u for a predetermined period.

Because the narrowband TDD system 110 shares uplink resources with the HDT system 120, uplink and downlink time slot switching points of the two systems are set on an alternating basis, such that an uplink (or downlink) for the broadband TDD should not be equal to an uplink (or downlink) for the narrowband TDD at the same time. Through the setting, the two TDDs can simultaneously operate independently when necessary. In addition, if needed, the HDT system can operate in an FDD mode using the narrowband TDD uplink resource 520u and the broadband TDD uplink resource 530u.

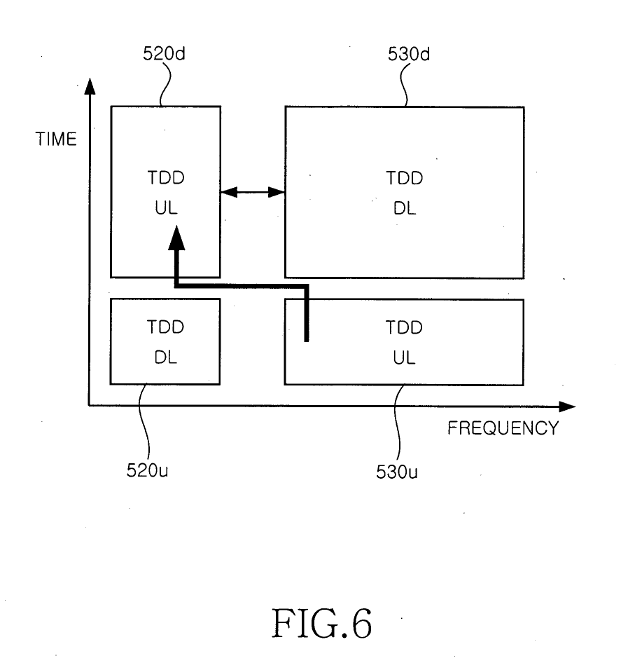

FIG. 6 is a resource graph illustrating an FDD mode of an HDT system in an EHDT duplexing method according to an embodiment of the present invention. As illustrated in FIG. 6, by alternately setting uplink and downlink time slot switching points of the narrowband TDD resource and the broadband TDD resource, the HDT system 120 can obtain continuity, which is a characteristic of the FDD mode, using the narrowband TDD uplink resource 520u and the broadband TDD uplink resource 530u.

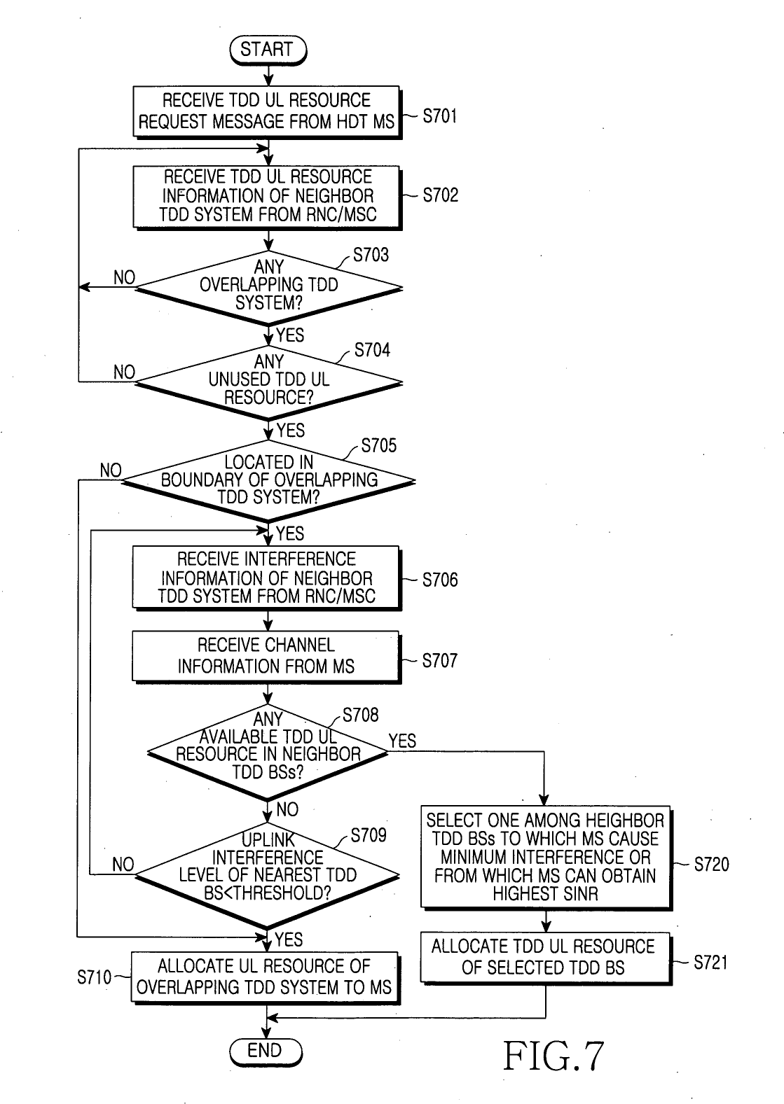

FIG. 7 is a flowchart illustrating an EHDT duplexing method according to an embodiment of the present invention. More specifically, the EHDT duplexing method illustrated in FIG. 7 is the same as the EHDT duplexing method illustrated in FIG. 4, except that the FDD uplink resource of FIG. 4 is replaced with the TDD uplink resource and the FDD system is replaced with the TDD system. Therefore, a detailed description thereof will be omitted herein for simplicity.

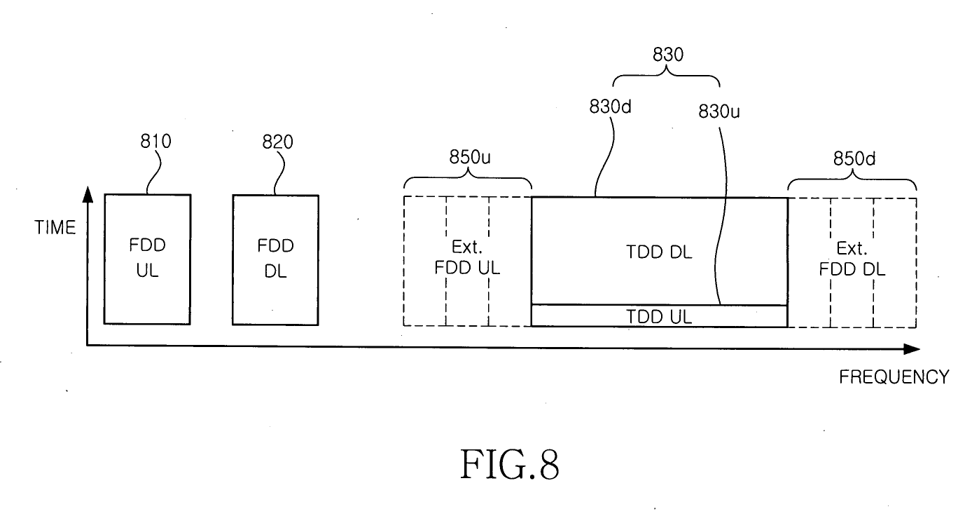

FIG. 8 is a conceptual diagram illustrating an EHDT duplexing method according to another embodiment of the present invention. In FIG. 8, a macro cell 110 is implemented with an FDD system that uses the existing FDD uplink resource 810 and downlink resource 820, and a micro cell 120 is implemented with an HDT system that uses TDD resource 830 of an additional band and FDD uplink resource 850u. FIG. 8 is similar in application to FIG. 2A except that the HDT system uses the FDD uplink resource 850u of the additional band as uplink resource, instead of the existing FDD uplink resource 810. Therefore, a detailed description thereof will be omitted herein for simplicity.

As described above, the EHDT system according to the present invention enables efficient resource management through resource sharing and reusing between hybrid duplexing technique-based systems in an overlay network where different type systems coexist.

In addition, the novel EHDT system can minimize intersystem interference by sharing or borrowing resources taking into account the resource utilization situations of the neighbor systems, and can maximize the entire system capacity through a traffic load balancing effect.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A wireless communication system in an overlay network in which systems using different frequency bands coexist, the wireless communication system comprising:
at least one first duplexing system utilizing a first duplexing technique through a first frequency band; and
at least one second duplexing system utilizing a second frequency band and a part of the first frequency band,
wherein the second duplexing system overlaps with the first duplexing system in coverage.

2. The wireless communication system of claim 1, wherein the first frequency band comprises:
an uplink band; and
a downlink band.

3. The wireless communication system of claim 1, wherein the second frequency band comprises:
an uplink time period; and
a downlink time period.

4. The wireless communication system of claim 1, wherein the first frequency band is no broader than the second frequency band in bandwidth.

5. The wireless communication system of claim 1, wherein the first duplexing system is a frequency division duplexing (FDD) system that divides the first frequency band into an uplink band and a downlink band for communication.

6. The wireless communication system of claim 5, wherein the second duplexing system is a hybrid duplexing technique (HDT) system that uses, for communication, both of a time division duplexing (TDD) technique that divides the second frequency band into an uplink time period and a downlink time period for communication, and a frequency division duplexing (FDD) technique that uses the downlink time period and the uplink band of the first frequency band.

7. The wireless communication system of claim 6, wherein the uplink band of the first frequency band is shared by the FDD system and the HDT system.

8. The wireless communication system of claim 6, wherein the uplink band of the first frequency band is borrowed by the HDT system.

9. The wireless communication system of claim 6, wherein a coverage area of the HDT system is smaller in radius than a coverage area of the FDD system.

10. The wireless communication system of claim 9, wherein the coverage area of the HDT system is divided into a circular inner region and a circular outer region.

11. The wireless communication system of claim 10, wherein the HDT system operates in a TDD mode using the uplink time period and the downlink time period of the second frequency band for the inner region, and operates in an FDD mode using the uplink band of the first frequency band and the downlink time period of the second frequency band for the outer region.

12. The wireless communication system of claim 1, wherein the first frequency band is divided into a first uplink time period and a first downlink time period.

13. The wireless communication system of claim 12, wherein the second frequency band comprises:
a second uplink time period; and
a second downlink time period.

14. The wireless communication system of claim 13, wherein the first frequency band is no broader than the second frequency band in bandwidth.

15. The wireless communication system of claim 14, wherein a switching point from the first uplink time period to the first downlink time period is equal to that from the second downlink time period to the second uplink time period.

16. The wireless communication system of claim 1, wherein the first duplexing system comprises a TDD system that divides the first frequency band into an uplink time period and a downlink time period for communication.

17. The wireless communication system of claim 16, wherein the second duplexing system comprises a hybrid duplexing technique (HDT) system that uses, for communication, both of a time division duplexing (TDD) technique that divides the second frequency band into an uplink time period and a downlink time period for communication, and a frequency division duplexing (FDD) technique that continuously uses the downlink time period of the second frequency band and the uplink time periods of the first and second frequency bands in a dime domain.

18. The wireless communication system of claim 17, wherein the uplink time period of the first frequency band is shared by the TDD system and the HDT system.

19. The wireless communication system of claim 17, wherein the uplink time period of the first frequency band is borrowed by the HDT system when necessary.

20. The wireless communication system of claim 17, wherein a coverage area of the HDT system is smaller in radius than a coverage area of the FDD system.

21. The wireless communication system of claim 20, wherein the coverage area of the HDT system is divided into a circular inner region and a circular outer region.

22. The wireless communication system of claim 21, wherein the HDT system operates in a TDD mode using the uplink time period and the downlink time period of the second frequency band for the inner region, and operates in an FDD mode using the uplink time periods of the first and second frequency bands and the downlink time period of the second frequency band for the outer region.

23. A wireless communication method in an overlay network in which different types of cellular systems for providing a communication service to mobile stations in their coverage using different frequency bands coexist, the wireless communication method comprising the steps of:
receiving, by a current system associated with a mobile station, a request for a resource of a different type system from the mobile station;
determining if there is an available resource of the different type system;
determining if the current system is located in a boundary of the different type system, if there is the available resource of the different type system; and
allocating resource of the different type system to the mobile station, if the current system is not located in the boundary of the different type system.

24. The wireless communication method of claim 23, wherein the step of determining if there is the available resource of the different type system comprises the steps of:
receiving resource information of the different type of systems from a control device that collectively manages the systems;
determining if there is a different type system whose coverage overlaps with a coverage of the current system, using the resource information; and
if there is an overlapping different type system, determining if there is a unused resource in the overlapping different type system.

25. The wireless communication method of claim 24, wherein the step of allocating the resource of the different type system to the mobile station comprises the steps of:
receiving interference information of neighbor different type systems from the control device, if the current system is located in the boundary of the different type system;
receiving channel information from the mobile station;
determining if there is an available resource in neighbor different type systems, using the resource information of the different type systems;
determining if an uplink interference level of the nearest different type system is lower than a predetermined threshold using the interference information, if there is no available resource; and
allocating resource of the different type system to the mobile station, if the uplink interference level of the nearest different type system is lower than the threshold.

26. The wireless communication method of claim 25, wherein the step of allocating resource of the different type system to the mobile station comprises the steps of:
selecting a different type system capable of having a minimum interference from the mobile station and obtaining a highest signal-to-interference plus noise ratio (SINR) among the different type systems using the interference information and channel information, if there is the available resource in the neighbor different type systems; and
allocating the available resource of the selected different type system to the mobile station.

27. The wireless communication method of claim 23, wherein the different type system is a frequency division duplexing (FDD) system that operates in an FDD mode.

28. The wireless communication method of claim 27, wherein the resource of the different type system is an FDD uplink resource.

29. The wireless communication method of claim 28, wherein the current system is a hybrid duplexing technique (HDT) system that uses, for communication, both of a time division duplexing (TDD) technique that divides a frequency band being different from the frequency band of the different type system into uplink resource and downlink resource in a time domain for communication, and a frequency division duplexing (FDD) technique that uses the FDD uplink resource and the downlink resource.

30. The wireless communication method of claim 29, wherein the FDD uplink resource is shared by the FDD system and the HDT system.

31. The wireless communication method of claim 29, wherein the FDD uplink resource is borrowed by the HDT system.

32. The wireless communication method of claim 29, wherein a coverage area of the HDT system is smaller in radius than a coverage area of the FDD system.

33. The wireless communication method of claim 23, wherein the different type system is a time division duplexing (TDD) system that operates in a TDD mode.

34. The wireless communication method of claim 33, wherein the resource of the different type system is a TDD uplink resource.

35. The wireless communication method of claim 34, wherein the current system is a hybrid duplexing technique (HDT) system that uses, for communication, both of a time division duplexing (TDD) technique that divides a frequency band being different from the frequency band of the different type system into uplink resource and downlink resource in a time domain for communication, and a frequency division duplexing (FDD) technique that uses the TDD uplink resource of the different type system, the uplink resource of the current system, and the downlink resource of the current resource.

36. The wireless communication method of claim 35, wherein the TDD uplink resource is shared by the TDD system and the HDT system.

37. The wireless communication method of claim 35, wherein the TDD uplink resource is borrowed by the HDT system.

38. The wireless communication method of claim 35, wherein a coverage area of the HDT system is smaller in radius than a coverage area of the FDD system.
